(19) United States
(12) Patent Application Publication
(10) Pub. No.: US 2010/0015504 A1
(43) Pub. Date: Jan. 21, 2010

(54) FUEL CELL

(75) Inventors: Sjoji Sekino, Tokyo (JP); Kenji Kobayashi, Tokyo (JP); Satoshi Nagao, Tokyo (JP); Tetsuaki Hirayama, Tokyo (JP); Takanori Nishi, Tokyo (JP)

Correspondence Address: YOUNG & THOMPSON, 209 Madison Street, Suite 500, Alexandria, VA, 22314, US

(73) Assignee: NEC CORPORATION, Tokyo (JP)

(21) Appl. No.: 12/530,439

(22) PCT Filed: Mar. 7, 2008
(86) PCT No.: PCT/JP2008/054201

§ 371 Date: Sep. 8, 2009

(30) Foreign Application Priority Data
Mar. 7, 2007 (JP) 2007-056732

(51) Int. Cl. H01M 2/08; H01M 2/02

(52) U.S. Cl. 429/35; 429/34

(57) ABSTRACT

Cut lines (61) are formed in a wicking member (60) for supplying fuel to an anode (32) of a unit cell (11). This makes it possible to supply a sufficient amount of fuel to the anode because not only fuel propagation inside the wicking member (60) but also a capillary force obtained through the cut lines of the wicking member (60) can be utilized. This is so because not only fuel propagation through continuous pores inside the wicking member (60) but also fuel propagation through the cut lines (61) can effectively be utilized. This makes it possible to supply fuel for a long time period even when the amount is small and the concentration is low, thereby generating electric power for a long time.

### TECHNICAL FIELD

The present invention relates to a fuel cell.

### BACKGROUND ART

A polymer electrolyte fuel cell includes a membrane and electrode assembly (to be referred to as an MEA hereinafter) having a structure in which an anode and cathode sandwich a polymer electrolyte membrane. A fuel cell having a structure in which liquid fuel is directly supplied to the anode is called a direct fuel cell. The power generating mechanism of this direct fuel cell is as follows. First, externally supplied liquid fuel is decomposed on a catalyst carried on the anode, thereby generating protons, electrons, and an intermediate product. The generated cations move toward the cathode through the polymer electrolyte membrane. The generated electrons move toward the cathode via an external load. Consequently, the protons and electrons react with oxygen in the air at the cathode. This reaction generates a reaction product, thereby generating electric power. For example, in a direct methanol fuel cell (to be referred to as a DMFC hereinafter) in which an aqueous methanol solution is directly used as liquid fuel, a reaction represented by formula 1 below occurs in the anode, and a reaction represented by formula 2 below occurs in the cathode.

CH₃OH+H₂O→CO₂+6H⁺+6e⁻ (1)

3/2O₂+6H⁺+6e⁻→3H₂O (2)

Since the polymer electrolyte fuel cell using liquid fuel is readily downsized and lightweighted, power supplies for various electronic apparatuses such as portable apparatuses are being extensively researched and developed in recent years. The polymer electrolyte fuel cell has as a basic configuration a minimum power generating unit called the MEA as a power generating portion. The MEA cannot be used as a power supply unless it is incorporated into a fuel cell having a structure for supplying fuel and extracting electric power. Note that when using the fuel cell as a power supply of an electronic apparatus such as a cell phone, a necessary voltage can be obtained by connecting a plurality of MEAs because the voltage of a single fuel cell is low.

When using the fuel cell as described above as a power supply of a small-sized apparatus such as a cell phone or as a stationary external charger, the main application is to use the fuel cell outside, so it is being expected to further downsize the cell. For this reason, it is being expected to develop a passive fuel cell capable of supplying fuel and air to a power generating cell without using any extra peripheral apparatuses such as a pump and fan.

An example of a fuel supply method of the passive fuel cell is to use a wicking member in a fuel vessel. This wicking member directly supplies fuel to the anode when inserted into the fuel vessel. This is so because the capillary force of the wicking member feeds methanol in the fuel vessel to the anode. The fuel cell can further be downsized by using this wicking member. Recently, therefore, many researches have been made on fuel cells using the wicking member.

For example, patent reference 1 (Japanese Patent Laid-Open No. 2003-0317745) has disclosed a fuel cell having a wicking sheet between a fuel chamber and the anode. In patent reference 1, the wicking sheet absorbs fuel by the capillary phenomenon, thereby uniformly diffusing the fuel in the entire anode. However, the structure of patent reference 1 has the problem that unused fuel readily remains inside the wicking member because the fuel retaining force of the wicking member is too strong.

Also, patent reference 2 (Japanese Patent Laid-Open No. 2004-171844) has disclosed a fuel cell using a wicking structure having two layers different in porosity in a fuel reservoir. In patent reference 2, the fuel cell includes a liquid retaining layer made of a material having a high porosity and a supply layer having a low porosity, and the supply layer draws up fuel from the liquid retaining layer occupying most of the fuel reservoir, thereby supplying the fuel to the anode. Accordingly, the efficient use of fuel inside the wicking member is disclosed. In the structure of patent reference 2, however, fuel readily stays in the liquid retaining layer, so fuel diffusion from the liquid retaining layer to the liquid supply layer hardly occurs. This makes the supply of fuel to the anode difficult. Also, since the liquid supply layer absorbs fuel more easily, the problem that fuel inside the wicking member cannot efficiently be supplied to the anode has not completely been solved.

Note that patent reference 3 (Japanese Patent No. 3,717,871) describes the formation of small holes in the wicking member on the anode side for the purpose of increasing the efficiency of exhaustion of carbon dioxide produced by power generation, but the small holes are not used in fuel propagation. Note also that patent reference 3 describes that the wicking member is installed on the cathode side and grooves are formed to improve the supply of oxygen, but does not describe the formation of any cut line extending through the wicking member.

### DISCLOSURE OF INVENTION

### Problems that the Invention is to Solve

As described above, fuel supply using the wicking member uses the phenomenon in which fuel propagates through adjacent continuous pores inside the wicking member. When pores are not occupied by a liquid, the above phenomenon occurs because the liquid itself propagates between the pores. By contrast, when pores are occupied by a liquid, adjacent pores are filled with the liquid. Therefore, the above phenomenon occurs because fuel diffuses in the liquid shared by adjacent pores, and propagates toward the anode. In the former case, fuel propagation depends on the ease with which a dried wicking member becomes wet or the ease with which the liquid enters. This fuel propagation is a phenomenon in which fuel propagates in a dried or slightly wet wicking member, and equivalent to a case in which the fuel cell is initially used or the fuel cell is reused after it has not been used for a long time. In the latter case, however, fuel propagation occurs under conditions close to fuel component diffusion in a liquid. Since the fuel diffusion rate controls fuel propagation like this, a factor such as a concentration difference has an effect.

When fuel having a certain concentration enters a dried or slightly wet pore in the wicking member, the fuel moves to an adjacent pore, and fuel having a set concentration is reached when the fuel fills the pore. By contrast, when a fuel component propagates between pores already occupied by a liquid, fuel propagation almost dominated by the diffusion rate of the fuel component in the liquid is main fuel propagation in a limited area in the contact interface of liquid droplets between adjacent pores. In the former case, fuel close to the set concentration directly propagates. However, since a liquid droplet having a surface tension moves to an unoccupied pore, this movement of the liquid droplet is a rate-determining step. On the other hand, in the latter case, the diffusion rate of the fuel component is presumably relatively high because the fuel component diffuses in the liquid. In practice, however, fuel diffusion occurs via a contact point between the surfaces of liquid droplets occupying adjacent pores. Unlike normal component diffusion in a liquid, therefore, the moving rate at this contact point also has an effect, so the fuel propagation rate is restricted by a factor other than the diffusion of the fuel component in the liquid. Also, in the latter case, the movement of the liquid droplet itself in the pore hardly occurs. This rather limits the propagation of the fuel component.

When the wicking member and anode are in direct contact with each other and a liquid itself is directly supplied to the anode as in the direct fuel cell, sufficient fuel is kept supplied, so the problems as described above hardly arise. However, in a fuel supply system using certain fuel supply control in order to increase the fuel utilization efficiency, the original characteristics of the wicking member have an influence on the fuel propagation rate. Especially in a liquid vaporization system including a fuel supply control membrane such as PTFE, the degree of contact between the fuel supply control membrane and wicking member sometimes has an influence on the supply amount of the fuel component. In this case, the wicking member may excessively retain a fuel component to be supplied to the anode, because the wicking member easily retains fuel. That is, if the fuel concentration in that portion of the wicking member which is adjacent to the fuel supply control membrane is insufficient, no sufficient fuel can be supplied to the anode through the fuel supply control membrane, and this causes influences such as a voltage drop or a short power generation time.

Accordingly, the present invention has been made to solve the problems as described above, and has its object to provide a fuel cell capable of supplying a sufficient amount of fuel to the anode.

### Means of Solving the Problems

To solve the problems as described above, a fuel cell according to the present invention is characterized by including a unit cell including an electrolyte, a cathode formed on one surface of the electrolyte, and an anode formed on the other surface of the electrolyte, and a wicking member which has a cut line formed in a thickness direction, and supplies fuel to the anode.

### EFFECT OF THE INVENTION

In the present invention, the wicking member has the cut line. This makes it possible to utilize not only fuel propagation inside the wicking member, but also a capillary force obtained through the cutting line of the wicking member. Therefore, a sufficient amount of fuel can be supplied to the anode.

### BRIEF DESCRIPTION OF DRAWINGS

FIG. 1 is a sectional view showing a configuration example of a fuel cell of the present invention;

FIG. 2 is a sectional view showing a configuration example of the fuel cell of the present invention;

FIG. 3 is a sectional view showing a configuration example of a conventional fuel cell;

FIG. 4A is a schematic view showing a configuration example of a wicking member of the present invention;

FIG. 4B is a schematic view showing a configuration example of a conventional wicking member;

FIG. 5 is a sectional view showing an example of the fuel cell of the present invention;

FIG. 6C is a schematic view showing a configuration example of the wicking member of the present invention;

FIG. 6D is a schematic view showing a configuration example of the wicking member of the present invention;

FIG. 6E is a schematic view showing a configuration example of the wicking member of the present invention;

FIG. 7F is a schematic view showing a configuration example of the wicking member of the present invention;

FIG. 7G is a schematic view showing a configuration example of the wicking member of the present invention;

FIG. 7H is a schematic view showing a configuration example of the wicking member of the present invention;

FIG. 8 is a sectional view showing a configuration example of the fuel cell of the present invention;

FIG. 9 is a sectional view showing a configuration example of the fuel cell of the present invention;

FIG. 10 is a sectional view showing a configuration example of the fuel cell of the present invention;

FIG. 11A is a sectional view showing a configuration example of a fuel cell stack of the present invention;

FIG. 11B is a sectional view showing a configuration example of a frame of the fuel cell stack of the present invention;

FIG. 12A is a sectional view showing a configuration example of the fuel cell stack of the present invention; and

FIG. 12B is a sectional view showing a configuration example of the frame of the fuel cell stack of the present invention.

### BEST MODE FOR CARRYING OUT THE INVENTION

Exemplary embodiments of the present invention will be explained in detail below with reference to the accompanying drawings.

### First Exemplary Embodiment

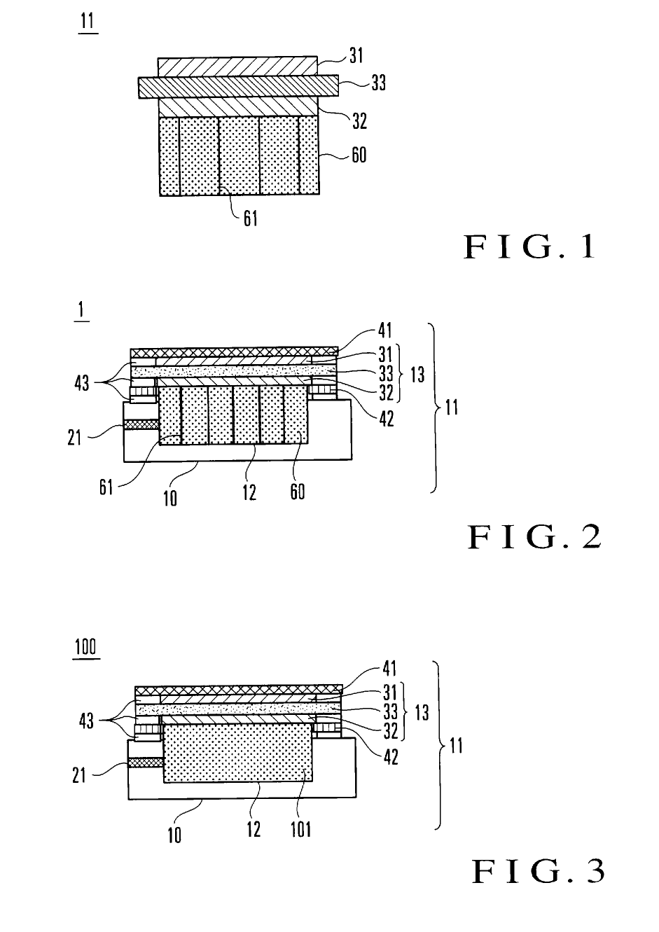

As shown in FIG. 1, a fuel cell 11 forming a fuel cell system according to the first exemplary embodiment includes at least a polymer electrolyte membrane 33, a cathode 31 formed on one surface of the polymer electrolyte membrane 33, an anode 32 formed on the other surface, and a wicking member 60 formed on that surface of the anode 32 which is opposite to the surface facing the polymer electrolyte membrane 33.

The wicking member 60 is made of a known fuel retaining agent such as woven fabric, unwoven fabric, a fiber mat, a fiber web, or a foamed polymer, and cut lines 61 are formed in the thickness direction.

The fuel cell 11 as described above is a direct methanol fuel cell directly using an aqueous methanol solution as liquid fuel. When this liquid fuel is supplied to the anode 32 via the wicking member 60, the reaction represented by formula (1) or (2) described previously occurs in the cathode 31 or anode 32, thereby generating electric power. Note that the basic component of the fuel is not necessarily limited to methanol, and it is also possible to apply alcohol-based fuel such as ethanol or ether-based fuel.

In this exemplary embodiment, the cut lines 61 are formed in the wicking member 60 as described above. This makes it possible to utilize not only fuel propagation inside the wicking member, but also a capillary force obtained through the cut lines of the wicking member. Accordingly, a sufficient amount of fuel can be supplied to the anode 32. This is so because it is possible to utilize not only fuel propagation through continuous pores inside the wicking member 60, but also fuel propagation through the cut lines 61. Therefore, the fuel can be supplied for a long time period even when the amount is small and the concentration is low. As a consequence, electric power can be generated for a long time.

### Second Exemplary Embodiment

The second exemplary embodiment of the present invention will now be explained. Note that in this exemplary embodiment, the same names and reference numerals as in the first exemplary embodiment denote the same constituent elements, and a repetitive explanation will be omitted.

<Features of Fuel Cell System>

As shown in FIG. 2, a fuel cell 11 forming a fuel cell system according to this exemplary embodiment includes a fuel tank unit 12 having a frame 10 as a recessed member, and a wicking member 60 is inserted into the fuel tank unit 12. In practice, the frame 10 has a structure capable of storing liquid fuel. Also, a fuel injection port 21 for injecting fuel is formed in the frame 10, so the fuel can be replenished any time. On the frame 10, an MEA 13 is set as it is sandwiched between collectors. More specifically, an anode collector 42 and cathode collector 41 are respectively positioned on the sides of an anode 32 and cathode 31, and sandwich the MEA 13, thereby performing current collection. The MEA 13 has a structure in which the cathode 31 and anode 32 face each other so as to sandwich a polymer electrolyte membrane 33. In addition, sealing members 43 are formed between the collectors for the purposes of insulation and sealing of a liquid leak. These power generating parts are fastened to the frame by a fixing method such as screwing. However, these parts need not always be fixed by screws, and need only have a structure capable of performing current collection and preventing a fuel leak. A structure like this forms the fuel cell 11.

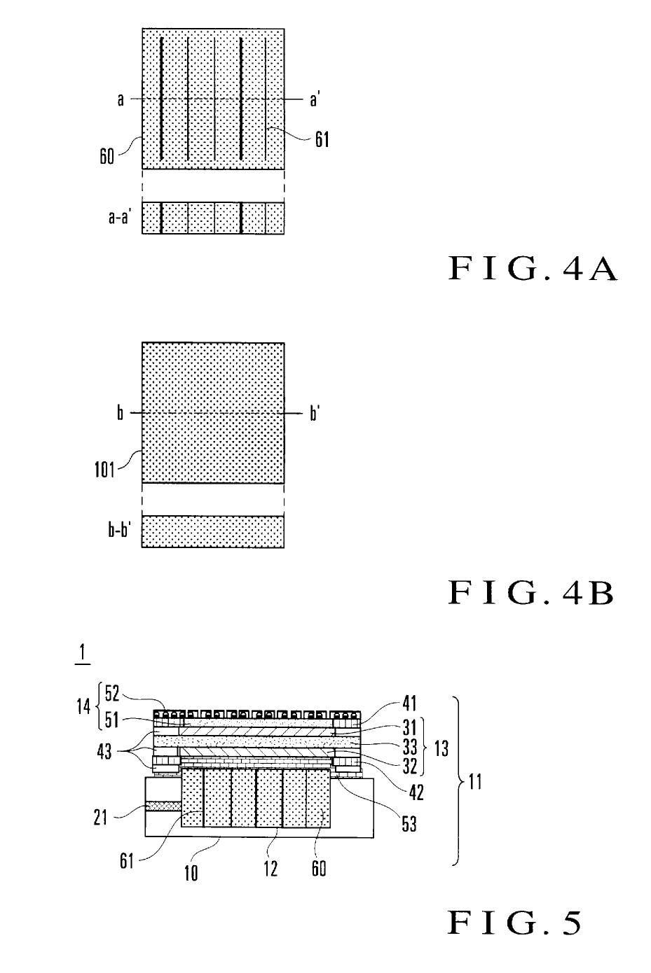

Similar to the first exemplary embodiment, the fuel cell system according to this exemplary embodiment shown in FIG. 2 differs from a conventional fuel cell system 100 shown in FIG. 3 in the arrangement of the wicking member 60. That is, cut lines are formed in the thickness direction in the wicking member 60 of the fuel cell system according to this exemplary embodiment. As shown in FIGS. 2 and 4A, cut lines 61 are formed in the wicking member 60. The cut lines 61 are formed in a direction in which fuel is drawn up to the anode 32. The cut lines 61 are also applicable to fuel supply performed via fuel supply control membrane 53 shown in FIG. 5.

On the other hand, in the conventional fuel cell system 100 shown in FIG. 3, no cut lines are formed in a wicking member 101 as is clearly shown in FIG. 4B. Note that in the conventional fuel cell system 100 shown in FIG. 3 and the like, the same names and reference numerals as in this exemplary embodiment denote the same constituent elements, and a repetitive explanation will be omitted.

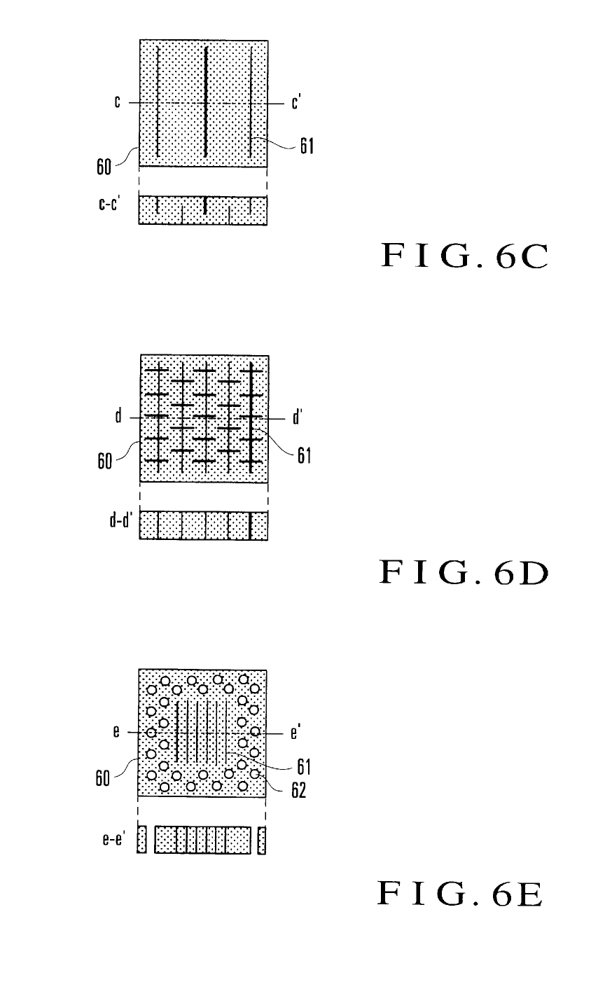

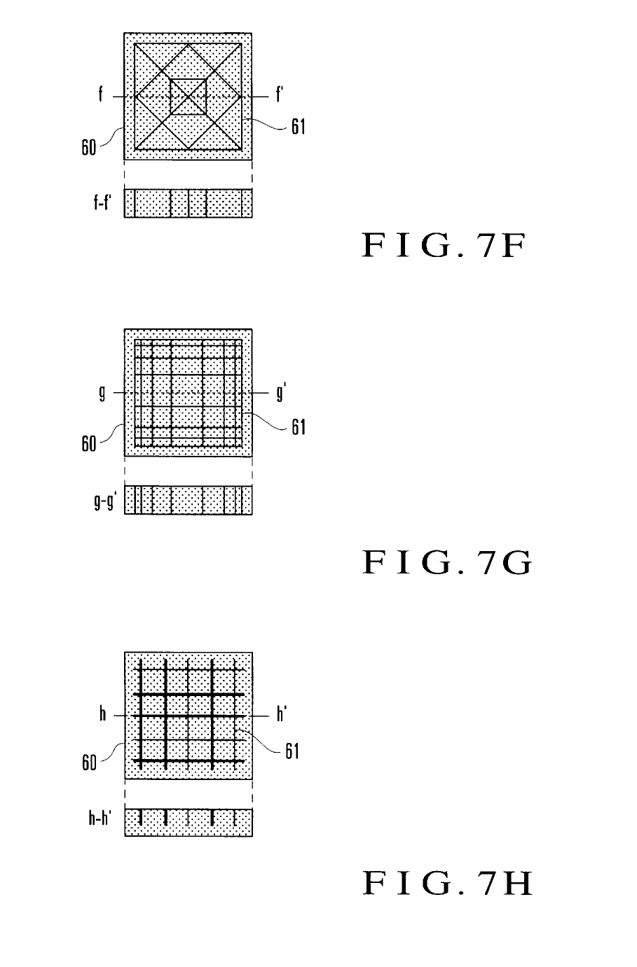

Note that the shape and arrangement of the cut lines 61 formed in the wicking member 60 are not limited to those shown in FIG. 4A, and can appropriately freely be set as shown in, e.g., FIGS. 6C to 7H.

Referring to FIG. 6C, for example, the cut lines 61 are formed so as not to extend from the upper surface to the lower surface. In this structure in which the cut lines 61 are formed so as not to extend through the wicking member, it is possible to make the density of the cut lines 61 on the upper surface different from that on the lower surface, thereby changing the ease with which fuel is absorbed inside the wicking member 60 or the ease with which the fuel is released.

Referring to FIG. 6D, branched cut lines 61 are formed as they are branched from the cut lines 61 shown in FIG. 4A. This structure of the cut lines 61 further promotes fuel propagation inside the wicking member, and facilitates releasing the fuel from the surface of the anode 32. This makes it possible to consume the fuel inside the wicking member more economically.

Referring to FIG. 6E, the cut lines 61 are formed in a portion of the wicking member 60, and small holes 62 are also formed. Note that the layout of the cut lines 61 and small holes 62 shown in FIG. 6E is not limited to that shown in FIG. 6E, and the shape of each small hole is also not limited to a circle.

Furthermore, it is possible to form the cut lines 61 in a peripheral portion and the small holes 62 in a central portion, or arrange the cut lines 61 and small holes 62 according to an appropriate rule or at random.

FIG. 7F shows an example in which the cut lines 61 are formed by combining lines forming nonparallel figures, instead of rows of parallel lines. FIG. 7F demonstrates that the effect of the cut lines 61 can be changed on the surface of the wicking member 60.

FIG. 7G is an example in which the cut lines 61 are arranged such that the density of the cut lines 61 on the surface increases toward a peripheral portion of the wicking member 60 and decreases toward a central portion. In this arrangement, fuel propagation occurs through the cut lines 61 more easily in the peripheral portion where the temperature is relatively lower than in the central portion where the temperature readily rises when electric power is generated.

FIG. 7H shows an example in which the cut lines 61 are formed in only one surface of the wicking member 60. For example, in the wicking member 60 having very good water absorption properties, the release of fuel determines the rate, so the supply of fuel to the anode 32 becomes insufficient. As shown in FIG. 7H, however, fuel propagation to the anode 32 is promoted even by forming the cut lines 61 in only the surface facing the anode 32.

<Configuration of Fuel Cell System>

Next, the arrangement of each constituent element of the fuel cell system according to this exemplary embodiment will be described in detail.

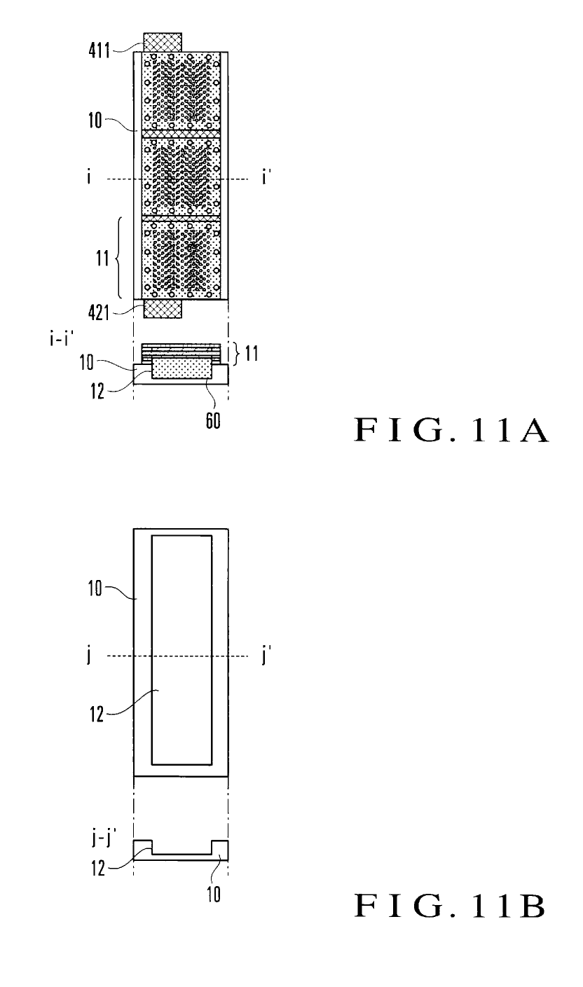

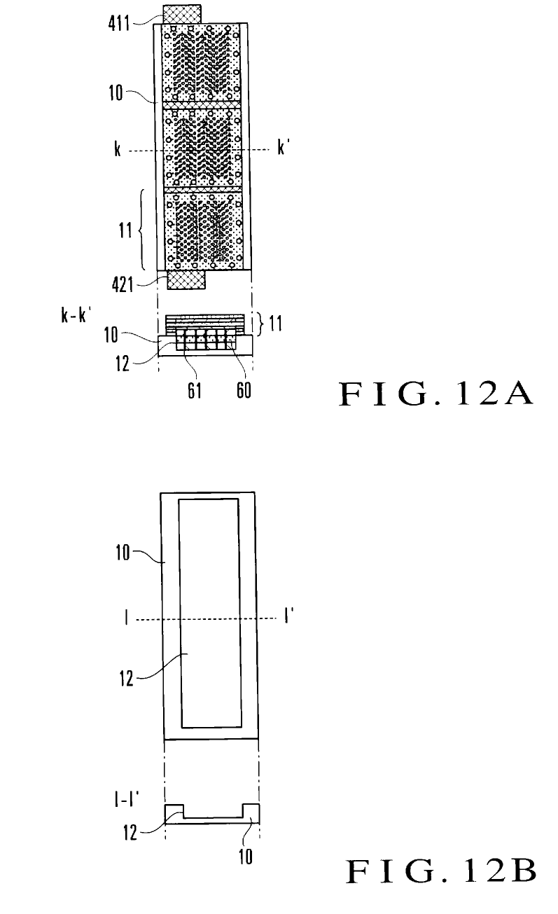

The fuel cell system according to this exemplary embodiment is not limited to the system including the single fuel cell 11 as shown in FIG. 2, and may also be systems in which a plurality of MEAs 13 or fuel cells 11 are connected in series or parallel as shown in, e.g., FIGS. 11A, 11B, 12A, and 12B. In these systems, the fuel tank unit 12 may be included in the plurality of fuel cells 11, or divided into the fuel cells 11. That is, the structure of the fuel cell 11 need only be based on the basic structure as shown in FIG. 2, 3, or 5, and the configuration of the whole fuel cell system is not limited to any specific cell structure.

(Fuel Cell)

The fuel cell 11 according to this exemplary embodiment will be explained in detail below. Note that the fuel cell 11 to be explained below is merely an example, and the present invention is not limited to the following fuel cell.

As described above, the wicking member 101 is inserted into the fuel tank unit 12 of the conventional fuel cell 100 shown in FIG. 3. Since the wicking member 101 has continuous pores, fuel is propagated through these continuous pores mainly by a driving force such as the capillary force, and supplied to the anode 32.

By contrast, as shown in FIG. 2, the fuel cell 11 according to this exemplary embodiment has the cut lines in at least the thickness direction of the wicking member 60 (FIG. 4A). This allows not only fuel propagation through the continuous pores inside the wicking member 60, but also fuel propagation through the cut lines. When fuel propagates through only the continuous pores in the wicking member 60, power generation stops if fuel necessary for power generation is not supplied to the anode 32 due to the fuel propagation degree. The fuel cell 11 of this exemplary embodiment prevents the stoppage of power generation like this. Also, even when the remaining amount of fuel becomes small, a large amount of fuel can be supplied to the anode 32 through the cut lines 61 when compared to the structure having no cut lines 61. Consequently, fuel in the fuel tank unit 12 can be supplied to the anode 32 more efficiently.

Furthermore, fuel can be supplied not only by direct supply by which the aqueous methanol solution as a liquid is in direct contact with the anode 32, by also by liquid vaporization performed through the fuel supply control membrane 53 as shown in FIG. 5. As the fuel supply control membrane 53, it is possible to use a hydrophobic PTFE porous film or hydrophilic electrolyte film. The material of the fuel supply control membrane can be freely selected from various materials, provided that fuel can be supplied from the fuel tank unit 12 to the anode 32.

As shown in FIG. 2 and the like, the fuel cell 11 includes at least the polymer electrolyte membrane 33, the cathode 31 formed on one surface of the polymer electrolyte membrane 33, the anode 32 formed on the other surface, the cathode collector 41 formed on that surface of the cathode 31 which is opposite to the surface facing the polymer electrolyte membrane 33, the anode collector 42 formed on that surface of the anode 32 which is opposite to the surface facing the polymer electrolyte membrane 33, and the sealing member 43 formed in the periphery of the polymer electrolyte membrane 33 and sandwiched between the polymer electrolyte membrane 33 and anode collector 42. Note that the polymer electrolyte membrane 33, cathode 31, and anode 32 form the MEA 13. The cathode collector 41 or anode collector 42 is formed on the upper or lower surface of the MEA 13 with the sealing member 43 being interposed between them.

The fuel cell 11 according to this exemplary embodiment is a direct methanol fuel cell directly using an aqueous methanol solution as liquid fuel, and power generation occurs when this liquid fuel is supplied to the anode 32. As described previously, the fuel cell 11 can also be applied to the method of vaporizing fuel through the fuel supply control membrane 53 and supplying the vaporized fuel. Note that the basic component of the fuel is not limited to methanol, and it is also possible to apply alcohol-based fuel such as ethanol, or ether-based fuel.

(MEA)

As described earlier, the MEA 13 has the arrangement in which the cathode 31 and anode 32 sandwich the polymer electrolyte membrane 33. As the polymer electrolyte membrane 33, it is desirable to use a polymer film having high proton conductivity and no electron conductivity. The constituent material of the polymer electrolyte membrane 33 is preferably an ion exchange resin having a polar group, e.g., a strong acid group such as a sulfonic acid group, phosphoric acid group, phosphone group, or phosphine group, or a weak acid group such as a carboxyl group. Practical examples are a perfluorosulfonic acid-based resin, sulfonated polyether sulfonic acid-based resin, and sulfonated polyimide-based resin. More practical examples are polymer electrolyte membranes made of aromatic polymers such as sulfonated poly(4-phenoxybenzoyl-1,4-phenylene), sulfonated polyether ether ketone, sulfonated polyether sulfone, sulfonated polysulfone, sulfonated polyimide, and alkyl sulfonated polybenzoimidazole. The film thickness of the polymer electrolyte membrane can suitably freely be set within the range of about 10 to 300 μm, in accordance with, e.g., the material or the purpose of the fuel cell.

(Cathode and Anode)

As indicated by formula (2), the cathode 31 is an electrode that reduces oxygen into water. For example, the cathode 31 can be obtained by forming a catalyst layer, which contains a proton conductor and particles (including a powder) formed by carrying a catalyst on a carrier such as carbon or a catalyst itself having no such carrier, on a base such as carbon paper by coating or the like. Examples of the catalyst are platinum, rhodium, palladium, iridium, osmium, ruthenium, rhenium, gold, silver, nickel, cobalt, molybdenum, lanthanum, strontium, and yttrium. It is possible to use only one type of catalyst, or combine two or more types of catalysts. As the particles carrying the catalyst, a carbon-based material such as acetylene black, ketjen black, a carbon nanotube, or a carbon nanohorn can be used. When the carbon-based material is particulate, for example, the size of the particles can appropriately freely be set within the range of about 0.01 to 0.1 μm and preferably about 0.02 to 0.06 μm. The catalyst can be carried by the particles by using, e.g., a dipping method.

As the base on which the catalyst layer is to be formed, it is possible to use a polymer electrolyte membrane, or a conductive porous material such as carbon paper, a molded product of carbon, a sintered product of carbon, a sintered metal, or a foamed metal. When using, e.g., carbon paper as the base, it is desirable to obtain the cathode 31 by forming a catalyst layer on the base, and then join the cathode 31 to the polymer electrolyte membrane 33 in a direction in which the catalyst layer is in contact with the polymer electrolyte membrane 33 by a method such as hot pressing. The catalyst amount per unit area of the cathode 31 can properly freely be set within the range of about 0.1 to 20 mg/cm², in accordance with, e.g., the type and size of the catalyst.

As indicated by formula (1), the anode 32 is an electrode that produces hydrogen ions, CO₂, and electrons from an aqueous methanol solution and water, and has the same arrangement as that of the cathode 31 described above. A catalyst layer and base forming the anode 32 can be the same or different from the catalyst layer and base forming the cathode 31. Similar to the cathode, the catalyst amount per unit area of the anode 32 can also suitably freely be set within the range of 0.1 to 20 mg/cm², in accordance with, e.g., the type and size of the catalyst.

(Collectors)

The cathode collector 41 and anode collector 42 are respectively formed in contact with the cathode 31 and anode 32. This increases the electron extraction efficiency and electron supply efficiency. The collectors 41 and 42 can have a frame-like shape in contact with the periphery of the MEA as shown in FIG. 2, or a plate-like shape or mesh-like shape in contact with the whole surface of the MEA. The shape can appropriately freely be set in accordance with, e.g., the convenience of design. As the material of the collectors 41 and 42, it is possible to properly freely use, e.g., a conductor such as stainless steel, a sintered metal, a foamed metal, a material formed by plating any of these metals with a highly conductive metal material, or a carbon material. In particular, to promote fuel supply by the wicking member 60, at least the anode-side collector preferably has as large a contact area as possible between the surfaces of the anode 32 and wicking member 60. This similarly applies to the structure using the fuel supply control membrane 53. Note that a fuel cell stack 15 in which the MEA structure itself includes a collecting structure is not limited to the system as described above, and need not include any collector.

(Sealing Members)

The fuel cell 11 according to this exemplary embodiment has the plurality of sealing members 43 having a sealing function. For example, as shown in FIGS. 2 and 5, the sealing member 43 having almost the same thickness as that of the cathode 31 is formed into a frame-like shape on the periphery of the cell structure between the polymer electrolyte membrane 33 and cathode collector 41, and the sealing member 43 having almost the same thickness as that of the anode 32 is formed into a frame-like shape on the periphery of the cell structure between the polymer electrolyte membrane 33 and anode collector 42. The sealing member 43 having an arbitrary thickness is formed between the anode collector 42 and frame 10. Note that these sealing members desirably have necessary sealing properties, insulation properties, and elasticity. The material of the sealing members as described above is normally made of, e.g., rubber or plastic having a sealing function. More specifically, the sealing members are made of a plastic material such as PTFE, PET, PEEK, or vinyl chloride, or a rubber material such as Teflon (registered trademark) rubber, silicone rubber, or butyl rubber. Note that a structure capable of electrical connection without any collector need only have a seal for exclusively preventing a fuel leak, and need not have all the sealing members 43 as described above.

(Fuel Tank Unit)

The fuel tank unit 12 is the recessed member having an opening in that surface of the frame 10 which is opposite to the anode 32, and has the fuel injection port 21 that allows the side surface of the frame 10 to communicate with the recessed portion. The number of the fuel injection port 21 is not limited to one; it is also possible to form a plurality of fuel injection ports 21 or pressure-releasing valves in order to facilitate replacement of air staying in the fuel tank unit 12 with fuel. Although various types of fuel injection ports 21 can be used in this exemplary embodiment, it is desirable to attach a check valve for preventing a reverse flow of the injected fuel because a leak or the like of the fuel can be prevented. It is also possible to suitably freely set, e.g., the shape and size of the fuel tank unit 12, but the opening facing the anode 32 is preferably equal to the anode electrode surface area. Furthermore, the thickness can also properly freely be set. However, if the distance from the bottom of the fuel tank unit 12 to the anode is too large, fuel may stay on the bottom of the fuel tank unit 12. Therefore, the thickness is desirably less than 10 mm for one fuel cell stack 15.

(Wicking Member)

A fuel retaining member normally called a wicking member is inserted into the tank unit 12. The wicking member 60 of this exemplary embodiment draws up and retains the aqueous methanol solution as fuel primarily by the capillary phenomenon, and supplies the fuel to the anode 32. The principle is as follows. The liquid fuel component propagates through a continuous pore formed inside the wicking member 60, propagates in a contact portion of an adjacent pore, diffuses in the liquid occupying the interior of the pore, and further propagates to another adjacent pore. The fuel is supplied to the anode 32 because this process repeats. Since methanol in the fuel component is consumed near the anode 32, a fuel concentration gradient is formed in the direction of the anode 32, and methanol diffuses by using this concentration gradient as a driving force. Note that fuel propagation through the continuous pores in the wicking member 60 does not diffuse in infinite directions unlike a simple diffusion phenomenon in a liquid, but occurs through only limited liquid contact portions of adjacent pores. This suppresses the fuel propagation rate.

As described above, the wicking member draws up fuel by using fuel propagation through the continuous pores as the basic principle. As the amount or concentration of fuel decreases, however, it becomes impossible to sufficiently supply fuel required for power generation in the fuel cell. Therefore, a fuel propagation path other than the continuous pores is effective to efficiently use charged fuel. By forming the cut lines 61 in the wicking member and drawing up fuel through the cut lines 61 as in this exemplary embodiment, the fuel can be supplied for a long time period even when the amount is small and the concentration is low. As a result, power generation can be performed for a long time. Practical examples of the cut lines 61 are the cut lines as shown in FIGS. 4A, 6C to 6E, and 7F to 7H. FIG. 4A shows an example of simplest cut lines 61; the cut lines are formed to extend through the wicking member in the thickness direction. To improve the function, as shown in, e.g., FIG. 6C, the cut lines 61 are not formed to extend through the wicking member, and the path of drawing up fuel to the wicking member 60 and the path of supplying the fuel to the anode 32 are separated. Also, as shown in, e.g., FIG. 6D, small cut lines 61 branched from main cut lines 61 are formed. This makes it possible to draw up even a small amount of fuel. Furthermore, as shown in, e.g., FIG. 6E, the cut lines 61 are not simple two-dimensional lines, and the wicking member 60 is partially cut out. Since liquid fuel can be retained in the cut portions of the wicking member 60 as well, a large amount of fuel can be retained.

As the material of the wicking member 60, it is possible to use, e.g., woven fabric, unwoven fabric, a fiber mat, a fiber web, or a foamed polymer. In particular, a foamed material of a polymer base such as urethane or a PVF-based material is desirable. Conventionally, hydrophilic materials have been used most often from the viewpoint of fuel retention. However, this poses the problem that if too much fuel is retained, the retained fuel is hardly released, so the fuel supplied to the anode 32 is not completely consumed compared to actually charged fuel. In this exemplary embodiment, therefore, the fuel propagation rate that can be controlled by only selecting the material of the wicking member 60 in the conventional fuel cell can be controlled by using the cut lines 61. Note that the structure of the wicking member 60 is not limited to the above-mentioned structure and can suitably freely be set, provided that fuel can be drawn up, retained, and released by forming the cut lines 61 or the like in the wicking member 60.

(Stack of Wicking Members)

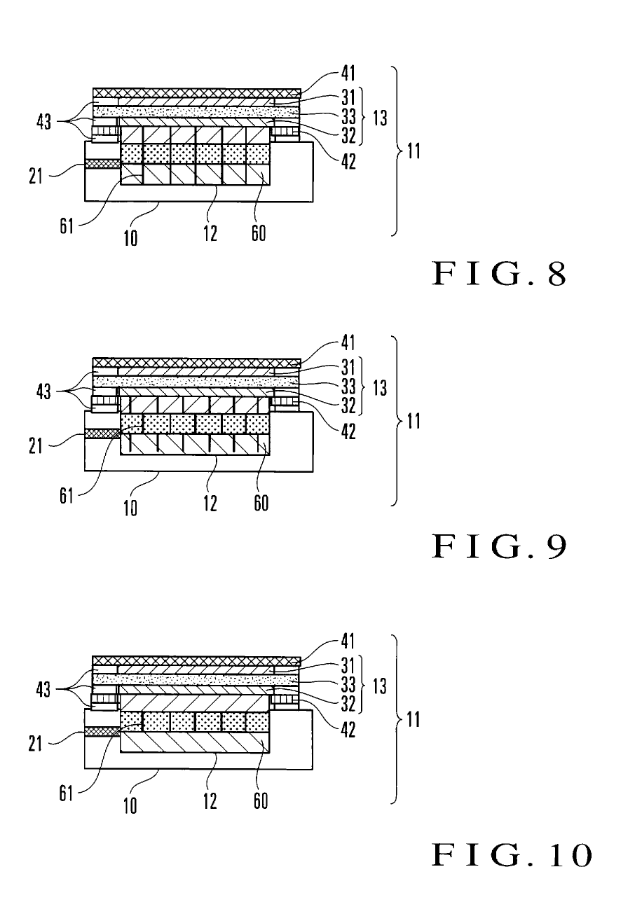

When the wicking member 60 is used as a single layer as described above, fuel supply can be improved by forming the cut lines 61. To further improve this effect, wicking members having different properties may also be stacked. In a structure shown in FIG. 8, for example, materials are stacked such that a most hydrophilic material is closest to the anode 32, a material having a large pore size and high porosity that facilitate retaining fuel is farthest from the anode 32, and a material having intermediate properties is sandwiched between them, and the cut lines 61 are formed. This makes it possible to utilize a fuel absorption difference and fuel retention difference in an inclined distribution. In a stacked structure like this, fuel is often retained in the wicking member 60 inserted closest to the anode 32 and hardly released. By forming the cut lines 61 as in this exemplary embodiment, it is possible to reduce the phenomenon in which fuel supply does not catch up with the amount necessary for power generation. Although the stack of the wicking members 60 is not necessarily limited to the three-layered structure as described above, the basic structure will be explained below by taking the three-layered structure as an example.

In a practical stacked structure of the wicking members 60, a material having a large pore size and high porosity is used as the lowermost layer to facilitate temporary fuel propagation when fuel is injected. A wicking member 60 made of a material having susceptibility to water higher than that of the lowermost wicking member 60 is stacked on it. In addition, a material having a higher hydrophilic nature is stacked adjacent to the anode 32. Since this stack can form a fuel propagation gradient from the fuel tank unit 12 toward the anode 32, fuel supply to the anode 32 can be promoted.

The structures shown in FIGS. 8 to 10 are examples of the stack of the wicking members 60 and the formation positions of the cut lines 61. Referring to FIG. 8, the cut lines 61 extend through all the wicking members 60. Therefore, the synergistic effect of this effect and the effect of stacking makes it possible to supply fuel at a low concentration. Also, when the cut lines 61 are staggered as shown in FIG. 9, it is possible to maintain longitudinal fuel propagation through the cut lines in each wicking member 60, and utilize lateral fuel propagation in the contact interfaces between the different wicking members 60. Accordingly, the uniformity of fuel in the MEA surface can be increased. Furthermore, the cut lines 61 are formed in only a fuel relay layer in FIG. 10. By thus stacking the wicking members 60 by combining the wicking member 60 having no cut lines 61, it is possible to prevent the draw of fuel from depending on only the characteristics of the wicking members 60. Note that the stacked structure is not limited to those described above and can appropriately freely be set by, e.g., combining the properties of the wicking members 60 such as the hydrophilic nature, hydrophobic nature, pore size, and porosity, or combining the shapes of the wicking members 60 as shown in FIGS. 4A and 6C to 7H.

In this exemplary embodiment as has been explained above, the cut lines 61 are formed in the wicking member 60 to be inserted into the fuel tank unit 12 of the fuel cell 11 forming the fuel cell system. Since this makes it possible to utilize not only fuel propagation inside the wicking member but also a capillary force obtained through the cutting lines of the wicking member, a sufficient amount of fuel can be supplied to the anode. This is so because it is possible to effectively utilize not only fuel propagation through continuous pores inside the wicking member 60, but also fuel propagation through the cut lines 61. It is also possible to further improve the effect of fuel propagation by stacking the wicking members 60 having the cut lines 61. Consequently, even when the remaining amount of fuel or the fuel concentration decreases, the fuel can be supplied to the anode 32, so stable power generation can be performed for a long time. In addition, the efficiency of fuel propagation can further be increased by variously changing the stack or the combination of the cut lines 61. Since the cut lines 61 can be formed very simply without changing the outer shape and the like of the wicking member, fuel can economically be used. Furthermore, since the cut lines are formed in the wicking member, fuel propagation through the cut lines formed in the wicking member can efficiently be used in addition to fuel propagation through continuous pores inside the wicking member. This makes it unnecessary to impose any special restrictions on elements such as the material, shape, and stacked structure of the wicking member unlike in the conventional fuel cell.

The fuel cell to which this exemplary embodiment is applied is applicable to various apparatuses such as a cell phone, a notebook personal computer, a PDA (Personal Digital Assistant), various cameras, a navigation system, and a portable music player. The fuel cell can also be used as an auxiliary power supply of any of these electronic apparatuses.

Examples of the present invention will be explained below.

### First Example

First, the structure of a fuel cell 11 according to the first example will be explained below.

Initially, fine catalyst-carrying carbon particles were prepared by causing carbon particles (ketjen black EC600JD manufactured by LION) to carry, at a weight ratio of 50%, fine platinum particles having a particle size of 3 to 5 nm. 5 wt % of a Nafion (registered trademark) solution (DE521 manufactured by Du Pont) were added to 1 g of the fine catalyst-carrying carbon particles, and catalyst paste for cathode formation was obtained by agitating the mixture. Carbon paper (TGP-H-120 manufactured by TORAY) as a base was coated with 1 to 8 mg/cm² of the catalyst paste, and the catalyst paste was dried, thereby manufacturing a 4 cm×4 cm cathode 31. On the other hand, catalyst paste for anode formation was obtained under the same conditions as those for producing the catalyst paste for cathode formation described above, except that fine platinum (Pt)-ruthenium (Ru) alloy particles (the ratio of Ru was 50 at %) having a particle size of 3 to 5 nm were used instead of the fine platinum particles. An anode 32 was manufactured under the same conditions as the above-mentioned cathode manufacturing conditions, except that this catalyst paste was used.

Then, a 6 cm×6 cm×180 μm (thickness) film made of Nafion 117 (having a number-average molecular weight of 250,000) was used as a polymer electrolyte membrane 33, the cathode 31 was placed on one surface in the thickness direction of the membrane such that the surface not coated with the catalyst was outside, and the anode 32 was placed on the other surface such that the surface not coated with the anode catalyst was outside. While the electrode surfaces coated with the catalysts were opposed to each other with the polymer electrolyte membrane 33 being interposed between them, host pressing was performed by applying pressure from outside each carbon paper, thereby manufacturing an MEA 13.

A 3-mm thick wicking member 60 having cut lines 61 as shown in FIG. 4A was inserted into a fuel tank unit 12. The cut lines 61 were formed at an interval of about 3 mm. As the wicking member 60, a hydrophilic material having a pore size of 50 μm and a porosity of 85% was used.

Subsequently, on the cathode 31 and anode 32, collectors 41 and 42 each made of a rectangular, frame-like stainless steel (SUS316) plate having outer dimensions of 5 cm×5 cm, inner dimensions of 3.8 cm×3.8 cm, and a thickness of 1.0 mm were placed on the two surfaces on the sides of the cathode 31 and anode 32, and fixed to a frame 10 by screwing. The frame 10 had the same outer dimensions as those of the above-mentioned collectors. The overall thickness was 5 mm, the depth of the fuel tank unit 12 on the inside was 3 mm, and the sectional structure was as shown in FIG. 2. A liquid leak was prevented by inserting a silicone rubber sealing member 43 between the anode 32 and frame 10.

Various wicking members 60 were inserted into the fuel tank unit 12 of the fuel cell system thus manufactured, and a power generation test to be described later was conducted. Note that each collector had an electrically connectable terminal, and was connected to a measurement apparatus via this terminal.

### Second Example

A fuel cell according to the second example will be explained below.

In this example, a 3-mm thick wicking member 60 as shown in FIG. 6C was inserted as a wicking member 60 of the second example. Cut lines 61 having a depth of 0.7 mm in the thickness direction were formed in the two surfaces of the wicking member 60. The rest of the arrangement such as the manufacturing method and structure of an MEA were the same as those of the first example.

### Third Example

A fuel cell according to the third example will be explained below.

In this example, a 3-mm thick wicking member 60 as shown in FIG. 6D was inserted as a wicking member 60 of the third example. The rest of the arrangement such as the manufacturing method and structure of an MEA were the same as those of the first example.

### Fourth Example

A fuel cell according to the fourth example will be explained below.

In this example, a 3-mm thick wicking member 60 as shown in FIG. 6E was inserted as a wicking member 60 of the fourth example. The diameter of small holes formed in the wicking member 60 of the fourth example was about 1 mm, and the small holes were arranged into a shape surrounding the cut lines. The rest of the arrangement such as the manufacturing method and structure of an MEA were the same as those of the first example.

### Fifth Example

A fuel cell according to the fifth example will be explained below.

In this example, a 3-mm thick wicking member 60 as shown in FIG. 7F was inserted. In this example, cut lines 61 of the wicking member 60 were not parallel straight lines as described so far, but formed in nonparallel directions as well. The rest of the arrangement such as the manufacturing method and structure of an MEA were the same as those of the first example.

### Sixth Example

A fuel cell according to the sixth example will be explained below.

In this example, cut lines 61 of a wicking member 60 were not formed at equal intervals as in the first example. Instead, the interval of the cut lines 61 in a peripheral portion was decreased, and the cut lines 61 were formed to perpendicularly intersect each other, in order to promote fuel propagation in the peripheral portion. The rest of the arrangement such as the manufacturing method and structure of an MEA were the same as those of the first example.

### Seventh Example

A fuel cell according to the seventh example will be explained below.

In this example, cut lines 61 of a wicking member 60 were formed into the shape of a lattice in only a surface facing an anode 32. The rest of the arrangement such as the manufacturing method and structure of an MEA were the same as those of the first example.

### Eighth Example

A fuel cell according to the eighth example will be explained below.

In this example, to give a wicking member 60 the sectional structure as shown in FIG. 8, a fuel supply layer made of a hydrophilic material having a pore size of 200 μm and a porosity of 85%, a fuel relay layer made of a hydrophilic material having a pore size of 500 μm and a porosity of 85%, and a liquid storage layer made of a hydrophobic material having a pore size of 800 μm and a porosity of 90% were formed in the order named from the side close to an anode 32, and cut lines 61 were formed to extend from a fuel tank unit 12 to the anode 32. The thickness of each wicking member 60 was 1 mm, i.e., the same as that of the fuel tank unit 12. The rest of the arrangement such as the manufacturing method and structure of an MEA were the same as those of the first example.

### Ninth Example

A fuel cell according to the ninth example will be explained below.

This example had a structure in which three wicking members 60 were inserted as in the eighth example. The difference from the eighth example was that cut lines 61 were alternately formed so as not to extend from a fuel tank unit 12 to an anode 32, in order to obtain the sectional structure as shown in FIG. 9. The rest of the arrangement was the same as that of the eighth example.

### 10th Example

A fuel cell according to the 10th example will be explained below.

This example had a structure in which three wicking members 60 were inserted as in the eighth example. The difference from the eighth example was that cut lines 61 were formed in only the fuel relay layer, in order to obtain the sectional structure as shown in FIG. 10. The rest of the arrangement was the same as that of the eighth example.

### 11th Example

A fuel cell according to the 11th example will be explained below.

This example had a structure in which three wicking members 60 were inserted as in the eighth example. The difference from the eighth example was that a fuel supply control member 53 as shown in FIG. 5 was used. A polytetrafluoroethylene porous film was used as the fuel supply control membrane 53. The sectional structure of the stacked wicking members 60 was as shown in FIG. 8. The rest of the arrangement was the same as that of the eighth example. Note that when using the fuel supply control membrane 53, direct supply of water to an MEA 13 was suppressed. Therefore, a moisture retaining member 51 for retaining water in the MEA 13 was formed on a cathode 31, and a cover member 52 for fixing the moisture retaining member 51 was formed as shown in FIG. 5.

### 12th Example

A fuel cell according to the 12th example will be explained below.

In this example, a fuel cell stack 15 was formed by connecting three fuel cells 11 used in the eighth example in series. As shown in FIG. 12B, a fuel tank unit 12 was installed inside a frame 10, and a wicking member 60 having cut lines 61 was inserted into the fuel tank unit 12. The wicking member 60 was shared by the three fuel cells 11. Electricity was extracted from a cathode terminal 411 and anode terminal 421. The basic configuration was the same as that of the above-mentioned fuel cell 11.

### First Comparative Example

The structure of a fuel cell used in the first comparative example to be compared with the examples of the present invention will be explained below.

In the first comparative example, the manufacturing method and structure of an MEA were the same as those of the first example. As a wicking member 60 of the first comparative example, a 3-mm thick wicking member 60 as shown in FIG. 4A was inserted, and the sectional structure was as shown in FIG. 3.

### Second Comparative Example

The structure of a fuel cell used in the second comparative example to be compared with the examples of the present invention will be explained below.

In the second comparative example, the manufacturing method and structure of an MEA were the same as those of the first example. As wicking members 60 of the second comparative example, three 1-mm thick wicking members 60 were inserted as shown in FIG. 8, thereby obtaining the structure of the wicking members 60 as in the eighth example. The difference from the eighth example was that no cut lines 61 were formed in the wicking members 60.

### Third Comparative Example

The structure of a fuel cell used in the third comparative example to be compared with the examples of the present invention will be explained below.

The third comparative example is an example in which a fuel cell stack 15 was formed by connecting three fuel cells 11 used in the first comparative example in series. As shown in FIG. 11B, a fuel tank unit 12 was installed inside a frame 10, and a wicking member 60 having cut lines 61 was inserted into the fuel tank unit 12. The wicking member 60 was shared by the three fuel cells 11. Electricity was extracted from a cathode terminal 411 and anode terminal 421. The basic configuration was the same as that of the above-mentioned fuel cell 11.

<Experimental Method>

A constant-current power generation test was conducted on the first to 12th examples and the first to third comparative examples described above by filling the fuel tank unit 12 with an aqueous 50-vol % methanol solution, and supplying a current value equivalent to a current density of 50 mA/cm² in an atmospheric environment (25° C., 50%). For the first to 11th examples and the first and second comparative examples, the measurement was stopped when the voltage became lower than 200 mV or when 240 minutes elapsed. For the 12th example and the third comparative example, the power generation was stopped when the voltage became lower than 900 V or when 120 minutes elapsed.

Table 1 shows the experimental results of the first to 11th examples and first and second comparative examples.

TABLE 1

| | Power | Voltage (mV) | | | | |
|---|---|---|---|---|---|---|
| | generation | | | | | 240 |
| | time (min) | Start | 30 min | 60 min | 120 min | min |
| 1st example | 100 | 430 | 400 | 350 | — | — |
| 2nd example | 115 | 430 | 410 | 380 | — | — |
| 3rd example | 130 | 420 | 420 | 390 | 250 | — |
| 4th example | 150 | 420 | 420 | 420 | 350 | — |
| 5th example | 110 | 420 | 410 | 370 | — | — |
| 6th example | 180 | 420 | 420 | 420 | 410 | — |
| 7th example | 160 | 420 | 410 | 390 | 350 | — |
| 8th example | 240 | 430 | 430 | 420 | 410 | 380 |
| 9th example | 240 | 430 | 430 | 420 | 410 | 350 |
| 10th example | 240 | 420 | 420 | 410 | 400 | 300 |
| 11th example | 240 | 410 | 410 | 410 | 410 | 400 |
| 1st comparative | 55 | 430 | 280 | — | — | — |
| example | | | | | | |
| 2nd comparative | 180 | 430 | 430 | 420 | 380 | — |
| example | | | | | | |

First, in the first comparative example as shown in Table 1, the power generation time was as short as 55 min, i.e., it was impossible to continue stable power generation. When supplying fuel by using the wicking member 60, the fuel normally propagates through continuous pores inside the wicking member 60. However, a thickness of 3 mm was large enough to absorb fuel but too large to release the retained fuel. Consequently, the power generation stopped although a sufficient amount of fuel remained in the fuel tank unit 12.

By contrast, the power generation time of the first example was about twice that of the first comparative example. Since fuel could propagate not only through the continuous pores inside the wicking member 60 but also through the cut lines 61, a larger amount of fuel could be supplied to the anode 32.

In the second example, the power generation time was longer by about 15 min than that of the first example. The reason was as follows. The fuel was drawn up from the bottom of the fuel tank unit 12, and propagated through the continuous pores inside the wicking member 60 once. Since the fuel separately propagated through the continuous pores and the cut lines 61 open toward the anode 32, the amount of fuel directly supplied from the cut lines 61 to the anode 32 reduced. This made it possible to efficiently use energy to be lost by a temperature rise.

In the third example, the power generation time was longer by about 30 min than that of the first example. This is so presumably because the amount of fuel remaining inside the wicking member 60 reduced, and the amount of fuel supplied to the anode 32 increased.

In the fourth example, a large amount of fuel could be stored because the liquid fuel stayed in the small holes 62. In addition, fuel supply by the wicking member 60 improved through the cut lines 61. This made it possible to continue power generation for a time period 1.5 times that of the first example.

The fifth example followed almost the same power generation process as that of the first example.

In the sixth example, fuel supply to the central portion of the MEA 13 where a temperature rise readily occurred relatively reduced, so the temperature of the peripheral portion where a temperature rise hardly occurred became sufficiently high. This significantly prolonged the power generation time.

In the seventh example, the same effect as that of the sixth example was obtained. Since the cut lines 61 did not extend to the anode 32 and the fuel often remained inside the wicking member 60 as a base, the power generation time was shorter than that of the fifth example, but the electric power could be generated for a time longer than that of the fourth example. In the second comparative example, the three wicking members 60 were stacked. Since the pore size of the lowermost wicking member was large, the fuel was efficiently supplied to the anode 32 through the fuel relay layer and fuel supply layer, while a larger amount of fuel was stored. This made it possible to greatly prolong the power generation time compared to the first comparative example.

As shown in FIG. 8, the eighth example differs from the second comparative example in that the cut lines 61 were formed to extend from the fuel tank unit 12 to the anode 32. As a result, stable power generation could be continued until 240 min.

In the ninth example, the cut lines 61 did not extend from the bottom of the fuel tank unit 12 to the anode 32. Accordingly, fuel propagation between the stacked wicking members 60 was propagation in contact portions of the wicking members 60. This slightly decreased the voltage after an elapse of 240 min when the remaining amount of fuel was small.

In the 10th example, the cut lines 61 were formed in only the fuel relay layer, so fuel propagation in the fuel relay layer improved. However, the amount of fuel retained in the fuel supply layer increased, and this slightly accelerated the voltage drop.

In the 11th example, it was possible to efficiently control fuel consumption because the fuel was supplied through the fuel supply control membrane 53. Therefore, a high voltage could be held even after an elapse of 240 min although the initial voltage was slightly low.

Table 2 shows the experimental results of the 12th example and third comparative example. Note that Table 2 shows the experimental results when using the fuel cell stack 15.

TABLE 2

| | Power | Voltage (V) | | | | |
|---|---|---|---|---|---|---|
| | generation | | | | | 240 |
| | time (min) | Start | 30 min | 60 min | 120 min | min |
| 12th example | 120 | 1.24 | 1.26 | 1.25 | 1.24 | 1.20 |
| 3rd comparative | 50 | 1.20 | 1.05 | — | — | — |
| example | | | | | | |

As shown in Table 2, in the third comparative example, it was impossible to obtain stable power generation for a long time period for the same reason as in the first comparative example.

By contrast, in the 12th example using the same structure of the wicking members 60 as that of the eighth example, it was possible to stably supply fuel for 120 min. Consequently, power generation could be continued with a stable voltage. The result of the 12th example reveals that the structure having the cut lines 61 in the wicking member 60 is effective even when using the fuel cell stack 15, and that even a passive fuel cell can stably generate a sufficiently high voltage.

As described above, the use of the methods of the present invention as disclosed in the first to 12th examples makes it possible to improve the balance between fuel retention and fuel release of the wicking member 60, and stably generate electric power for a long time. Especially when combining the cut lines 61 and stacked structure for the wicking member 60, the power generation time can be prolonged by a stabler voltage transition.

1. A fuel cell comprising:
a unit cell including an electrolyte, a cathode formed on one surface of said electrolyte, and an anode formed on the other surface of said electrolyte; and
a wicking member which has a cut line formed in a thickness direction, and supplies fuel to said anode.

2. A fuel cell according to claim 1, wherein the cut line of said wicking member includes a plurality of cut lines.

3. A fuel cell according to claim 2, wherein in said wicking member, an interval of the cut lines in a peripheral portion is smaller than that in a central portion.

4. A fuel cell according to claim 2, wherein said wicking member has holes which surround the cut lines and have a diameter of not more than 3 mm.

5. A fuel cell according to claim 1, wherein said wicking member has a plate-like shape and includes a plurality of wicking members stacked in the thickness direction.

6. A fuel cell according to claim 5, wherein at least one of said wicking members is formed to be different from other wicking members in at least one of a porosity, a pore size, and water absorption properties.

7. A fuel cell according to claim 5, wherein an affinity of said wicking members for the fuel increases from the fuel to said anode.

8. A fuel cell according to claim 1, wherein
the fuel is supplied through a fuel supply control membrane, and
a main material of said fuel supply control membrane is a hydrophobic film.

9. A fuel cell according to claim 1, wherein the fuel is liquid fuel.

10. A fuel cell according to claim 1, further comprising a frame which is formed on a surface of said anode which is opposite to a surface facing said electrolyte, and has a recessed member which opens toward said anode and to which the fuel is supplied,
wherein said wicking member is installed inside said recessed member.

11. A fuel cell according to claim 1, further comprising:
a cathode collector in contact with a surface of said cathode which is opposite to a surface facing said electrolyte; and
an anode collector in contact with a surface of said anode which is opposite to a surface facing said electrolyte.

12. A fuel cell according to claim 11, further comprising:
a first sealing member formed in a periphery of said cathode; and
a second sealing member formed in a periphery of said anode,
wherein said cathode collector is formed on the surface of said cathode which is opposite to the surface facing said electrolyte with said first sealing member being interposed between said cathode collector and said cathode, and
said anode collector is formed on the surface of said anode which is opposite to the surface facing said electrolyte with said second sealing member being interposed between said anode collector and said anode.

13. A fuel cell according to claim 3, wherein said wicking member has holes which surround the cut lines and have a diameter of not more than 3 mm.

14. A fuel cell according to claim 2, wherein said wicking member has a plate-like shape and includes a plurality of wicking members stacked in the thickness direction.

15. A fuel cell according to claim 3, wherein said wicking member has a plate-like shape and includes a plurality of wicking members stacked in the thickness direction.

16. A fuel cell according to claim 4, wherein said wicking member has a plate-like shape and includes a plurality of wicking members stacked in the thickness direction.

17. A fuel cell according to claim 6, wherein an affinity of said wicking members for the fuel increases from the fuel to said anode.

18. A fuel cell according to claim 2, wherein
the fuel is supplied through a fuel supply control membrane, and
a main material of said fuel supply control membrane is a hydrophobic film.

19. A fuel cell according to claim 3, wherein
the fuel is supplied through a fuel supply control membrane, and
a main material of said fuel supply control membrane is a hydrophobic film.

20. A fuel cell according to claim 4, wherein
the fuel is supplied through a fuel supply control membrane, and
a main material of said fuel supply control membrane is a hydrophobic film.
